(19) United States
(12) Patent Application Publication
(10) Pub. No.: US 2021/0365617 A1
(43) Pub. Date: Nov. 25, 2021

(54) DESIGN AND OPTIMIZATION ALGORITHM UTILIZING MULTIPLE NETWORKS AND ADVERSARIAL TRAINING

(71) Applicant: Robert Roe, Upper Saddle River, NJ (US)

(72) Inventor: Robert Roe, Upper Saddle River, NJ (US)

(21) Appl. No.: 17/328,997

(22) Filed: May 24, 2021

Related U.S. Application Data
(60) Provisional application No. 63/029,317, filed on May 22, 2020.

(51) Int. Cl. G06F 30/27; G06N 3/04

(52) U.S. Cl. CPC G06F 30/27; G06F 2111/06; G06N 3/0454

(57) ABSTRACT

A method of design optimization includes training adversarial combined networks including a discriminator network and a generator network. The method is capable of performing multi-objective optimization and may be more efficient than existing methods for certain problems.

### CROSS-REFERENCE TO RELATED APPLICATIONS

This application claims priority to U.S. Provisional Application No. 63/029,317, filed on May 22, 2020, the disclosure of which is herein incorporated by reference in its entirety.

### TECHNICAL FIELD

The invention relates to machine learning, and more particularly, to the use of an adversarially trained set of neural networks to perform optimization-related tasks.

### BACKGROUND

Multiple adversarially trained networks can be trained and subsequently used to produce new output data for a specific task. For example, after being trained on a set of photographs, Generative Adversarial Networks (GANs) (e.g. a generator network and a discriminator network) can be capable of creating new, nearly photorealistic images.

Optimization algorithms rely on evaluations of candidate designs, and the data gleaned from these evaluations are used to direct progress. These evaluations can be costly, and a primary criterion when choosing an optimization algorithm is its ability to use the information provided by these evaluations efficiently, reducing the number of evaluations required. A more efficient optimization algorithm will require fewer candidate evaluations to converge toward the optimum, however, optimization algorithms are not perfectly efficient for most optimization problems.

In light of the costs associated with evaluating candidates, many optimization algorithms operate on a simplified version of the true problem, with a reduced number of design variables, in order to be practical. Such simplifications or parameterizations may enable the optimization algorithm to make more efficient use of evaluation data, but also limit the search space and may slow the algorithm or prevent it from finding the true optimum.

Most optimization algorithms cannot account for the relationships between design variables or degrees of freedom, and thus fail to take full advantage of the evaluation data they receive. Therefore, there remains a need for a more efficient way to optimize designs.

### SUMMARY

This invention relates to the use of multiple networks and adversarial training to perform design and optimization tasks. The multiple networks comprise a discriminator network and a generator network. The generator network can be trained in an adversarial manner with the discriminator network. During adversarial training, a combined adversarial network containing the discriminator network and generator network is created, such that the candidates output by the generator are fed into the discriminator as input. The generator network may also be trained separately. This discriminator network and generator network arrangement is similar to that of Generative Adversarial Networks (GANs). GAN research focuses on using GANs to create realistic images, video, and audio. In that context, the discriminator network can act as a classifier, classifying the generated content as either real or fake. In the current invention, the discriminator network may perform regression. Furthermore, the network arrangement may be similar to that of Conditional Generative Adversarial Networks (CGANs).

Disclosed herein are various exemplary methods for the use of multiple networks and adversarial learning in design and optimization. This may include one or more computer-readable storage media that include process-executable instructions to instruct a computer system to execute the invention described herein.

In an exemplary implementation, the current invention relies on an iterative process. First, the discriminator network is trained on a candidate database of design candidates, which are labeled with one or more metrics. This database may be initially populated with existing, human-designed candidates, random noise, or any other type of candidate, so long as the labels are reasonably accurate. Next, the generator network is trained via the adversarial method, during which it typically learns to exploit inaccurate regions of the discriminator. The generator network is then used to create new design candidates which it estimates to be nearly optimal. Those new candidates are evaluated via the objective function, and the new candidates and labels are added to the database of design candidates. The process then repeats. When the discriminator is trained again on the expanded database, inaccuracy in the region that had previously been exploited by the generator is dramatically reduced. Thus, when the generator network is retrained, it must find a new region to exploit. After many repetitions of the process, both the discriminator network and the generator network become highly accurate in the region or regions near the optimum or optima, and the candidates produced by the generator network become more optimal.

### BRIEF DESCRIPTION OF THE DRAWINGS

The above and further aspects of this invention are discussed with reference to the following descriptions in conjunction with the accompanying drawings, in which like numerals indicate structural elements and features in the various figures. The drawings are not necessarily to scale, emphasis instead being placed upon illustrating principles of the invention. The figures depict one or more implementations of the inventive methods, by way of example only, not by way of limitation.

FIG. 1 is a diagram of a non-limiting, exemplary sequence of the combined adversarial network training and utilization according to aspects of the present invention.

FIG. 2 is a diagram of a non-limiting, exemplary sequence of the combined adversarial network training and utilization according to aspects of the present invention.

FIG. 3 is a diagram of a non-limiting, exemplary sequence of the combined adversarial network training and utilization according to aspects of the present invention.

FIG. 4 is a diagram of a non-limiting, exemplary sequence of the combined adversarial network training and utilization according to aspects of the present invention.

FIG. 5 is a diagram of a non-limiting, exemplary sequence of the combined adversarial network training and utilization according to aspects of the present invention.

FIG. 6 is a diagram of a non-limiting, exemplary sequence of the combined adversarial network training and utilization according to aspects of the present invention.

FIG. 7 is a diagram of a non-limiting, exemplary sequence of the combined adversarial network training and utilization according to aspects of the present invention.

FIG. 8 is a diagram of a non-limiting, exemplary sequence of the combined adversarial network training and utilization according to aspects of the present invention.

FIG. 9 is a diagram of a non-limiting, exemplary sequence of the combined adversarial network training and utilization according to aspects of the present invention.

FIG. 10 is a diagram of a non-limiting, exemplary sequence of the combined adversarial network training and utilization according to aspects of the present invention.

FIG. 11 is a diagram of a non-limiting, exemplary sequence of the combined adversarial network training and utilization according to aspects of the present invention.

FIG. 12 is a diagram of a non-limiting, exemplary sequence of the combined adversarial network training and utilization according to aspects of the present invention.

FIG. 13 is a diagram of a non-limiting, exemplary sequence of the combined adversarial network training and utilization according to aspects of the present invention.

FIG. 14 is a diagram of a non-limiting, exemplary sequence of the combined adversarial network training and utilization according to aspects of the present invention.

FIG. 15 is a diagram of a non-limiting, exemplary sequence of the combined adversarial network training and utilization according to aspects of the present invention.

FIG. 16 is a diagram of a non-limiting, exemplary sequence of the combined adversarial network training and utilization according to aspects of the present invention.

FIG. 17 is a diagram of a non-limiting, exemplary sequence of the combined adversarial network training and utilization according to aspects of the present invention.

FIG. 18 is a diagram of a non-limiting, exemplary sequence of the combined adversarial network training and utilization according to aspects of the present invention.

FIG. 19 is a diagram of a non-limiting, exemplary sequence of the combined adversarial network training and utilization according to aspects of the present invention.

FIG. 20 is a diagram of a non-limiting, exemplary sequence of the combined adversarial network training and utilization according to aspects of the present invention.

FIG. 21 is a non-limiting, exemplary conceptual diagram of the combined adversarial network during training and utilization according to aspects of the present invention.

### DETAILED DESCRIPTION

It is to be understood that the present disclosure may assume various alternative variations and step sequences, except where expressly specified to the contrary. It is also to be understood that the specific processes illustrated in the attached drawing, and described in the following specification, are simply exemplary and non-limiting embodiments or aspects.

No aspect, component, element, structure, act, step, function, instruction, and/or the like used herein should be construed as critical or essential unless explicitly described as such.

Provided are improved methods for training, providing, and/or using an adversarial network. A generator network is trained to fool a discriminator network, which tries to discriminate between the design candidates as provided from the candidate database.

In one embodiment, the invention can be configured to perform single-objective optimization. Following the single-objective optimization, the generator network can be capable of producing an optimal or nearly optimal design candidate based on that single-objective. In this embodiment, the generator and discriminator may make use of any number of different types of network layers. In this embodiment, the discriminator network training may make use of one of the common loss functions, such as mean squared error. In this embodiment, the adversarial training of the generator may also make use of one of the common loss functions. If so, the generator network may take a desired output value of the objective function as input, and the discriminator network may provide an estimate of the output value of the objective function as an output. In this embodiment, minimization of the objective function may be accomplished by inputting low values, for example, just low enough to be unachievable, into the generator network during adversarial training. To provide variety of input to the generator network, some random variation in this number may be desirable. An analogous method may be used to maximize the objective function.

In at least one embodiment, the invention may utilize a computer or a computer network. The computer network may include one or more information storage devices, one or more computers, one or more network interfaces and one or more sets of instructions. As to the one or more computers, each computer may include one or more processors and memory for storing instructions, for example, executable by at least one of the one or more processors. As an example, a computer may include one or more network interfaces, one or more graphic cards, a display interface, etc.

Depending upon the problem that the user is trying to solve, a variety of different network architectures, network inputs, network outputs and loss functions may be used.

In one embodiment, to train the generator network more effectively, a special loss function or loss functions may be used. These one or more loss functions, in combination with the inputs to the adversarial training, may be adjusted to meet the needs of the optimization problem, recognizing that there may be many effective combinations. When minimizing a particular metric, the metric itself or a multiple of the metric or the metric raised to a power or similar may be used as a loss function.

When maximizing a particular metric, the inverse of the metric or the inverse of a multiple of the metric, or the inverse of the metric raised to a power or similar may be used as a loss function. It may be advantageous to train the generator network separately at times in addition to the adversarial training, for example, at the start of the optimization process.

Because both the discriminator network and the generator network can have any number of inputs, outputs, and loss functions, one embodiment of the current invention can optimize any number of objectives simultaneously. When employed for multi-objective optimization, the generator network can produce an infinite number of design candidates depending on the values of its inputs. By adding an extra input to the generator network and an extra input or output to the discriminator network in the single-objective architecture previously described, for example, the invention can be made to produce a set of solutions that vary with the additional input. To find the design candidate which matches a target value of a particular metric, objective function, or quality weight an input channel may be dedicated to the particular metric, objective function, or quality weight and then the target particular metric, objective function, or quality weight may be passed as an input to that channel. By passing in different target values for each sample in the adversarial training set, the combined network can be taught to produce an infinite, continuously varying set of solutions which nearly match the input target values. Any number of extra optimization dimensions may be added in this way.

The generator network may produce a number of geometries including two-dimensional or three-dimensional shapes. For example, if the generator network produces two-dimensional shapes, its output can be lofted to create a three-dimensional geometry with properties that vary smoothly in the third dimension.

Instead of or in addition to a target value, a quality weight factor can be input into the generator network, and an additional input or output added to the discriminator. This factor specifies the relative importance of competing metrics or objectives, and allows the invention to perform multi-objective optimization. Where the true optimum varies smoothly with the input, the generator network output may also vary smoothly along the Pareto front. Any number of extra dimensions may be added to the optimization in this way.

The discriminator network, generator network, and combined adversarial network and training system may be constructed to penalize certain candidates. For instance, one or more additional network inputs or outputs or both may be added to one or more networks, which can be used to enforce constraints on the design variables. This may be useful, for example, to prevent the generator network from creating infeasible candidates. Infeasible here may mean any candidate that the user deems not only suboptimal, but unworkable, any candidate which violates one or more constraints, and/or any candidate which the objective function cannot evaluate with its normal accuracy, precision, or efficiency. The networks may also be constructed to perform classification in addition to or instead of regression, for the purpose of enforcing constraints or for any other purpose. During training of any of the discriminator network, the generator network, and the combined adversarial network, it is possible to tune the loss function (e.g. via quality weights) such that the generator network is unlikely to produce infeasible designs.

In one embodiment, to train the generator network more effectively, a special loss function or loss functions can be used. The one or more loss functions, in combination with the inputs to the adversarial training, can be adjusted to meet the needs of the optimization problem, recognizing that there may be many effective combinations. The one or more loss functions may comprise any of the loss functions previously mentioned in this document, any combination thereof, and many other possible functions besides. The one or more loss functions may also comprise the use of one or more quality weights which can be varied to steer the optimization in specific direction(s). The one or more loss functions may also be constructed to cause the generator network output to meet a target value, which is an input to the generator network. The one or more loss functions may also be constructed to cause the generator network output to meet certain constraints. The one or more loss functions may also be constructed to weight certain regions of the design space more heavily than others, in accordance with their importance to the user. The one or more loss functions may or may not depend on either the desired values of the objective or the estimated values of the objective.

In order to explore new areas of the design space and take advantage of parallel evaluation of design candidates, it may be advantageous to add noise, especially within the generator. In one embodiment of the present invention, the method of optimization may comprise the addition of noise into the discriminator network. The method of optimization may comprise the addition of noise or one or more noise layers into the generator network. This noise may be added at the beginning of the generator network, at the end of the generator network, or anywhere within it.

The networks may learn to compensate for this noise in areas of the design space where data is most dense, giving the network a naturally Bayesian quality. Explicitly Bayesian networks may also be beneficial. The method of optimization may comprise the use of a Bayesian discriminator network. The method of optimization may comprise the use of a Bayesian generator network.

Because the algorithm comprises multiple processes, including some conventional machine learning processes, a new layer of hyperparameters is introduced in addition to those associated with conventional network training. Systematic adjustment of these hyperparameters may accelerate the optimization process.

In addition to adjusting the learning rate, as is common when training neural networks, it may be advantageous to adjust the batch sizes, epoch sizes, and numbers of epochs per optimizer iteration as the optimization progresses. This may help to prevent wasted training and maintain balance between the discriminator network and the generator network. This invention comprises such adjustment. A simple approach is to adjust the amount of training such that training stops when progress slows. For example, the networks' learning rates, batch sizes, epoch sizes, and numbers of epochs per optimizer iteration may be adjusted as the optimization progresses such that training of each network stops when a specified fraction of additional epochs yield a reduction in loss.

As the combined network optimization progresses and design candidates near the optimum, the rate of progress may decrease. The difference in objective function values between successive candidates may be orders of magnitude larger at the start of the optimization than at the end. Some intervention may therefore be required in order to prevent early, far-from-optimal candidates from swamping later, more refined candidates during the discriminator training. An “importance” weighting, which gives more weight to well-performing, better-performing, or the best-performing candidates in the loss function, can solve this problem. For example, when minimizing an objective function in the form of a sum of squares, using a weight which is proportional to the value of that objective raised to the power of −2 will keep the weighted error balanced between samples. Similarly, the loss function may be constructed to give more weight to more recently generated candidates.

Because the distance to the optimum falls as the optimization progresses, it may be advantageous to have the noise also diminish. The method of optimization may comprise the adjustment of the noise levels as the optimization progresses. Fastest convergence is achieved when the scale of this noise is in the correct proportion to the remaining distance to the optimum. A systematic method for adjusting the noise is therefore useful. One example of such a method is to periodically adjust the noise such that the standard deviation of objective function values in samples with noise is in constant proportion to the difference between the mean of objective function values in samples with noise and the mean of objective function values in samples without noise. Note that in this instance it is necessary to generate and evaluate some candidates without noise. Including some of these noiseless candidates may also accelerate convergence. The invention comprises the systematic adjustment of noise as the algorithm progresses.

Rather than generate training batches for the discriminator at random from the database of evaluated candidates, it may be advantageous to include more recent candidates and well-performing, better-performing, or the best-performing candidates more frequently, or some combination thereof. In one embodiment, the current invention comprises a method for creating training batches wherein some candidates from the database are sampled more frequently than others. Likewise, during the training of the combined adversarial network, it may be advantageous to generate more candidates in certain regions of the design space. In one embodiment, the current invention comprises a method for focusing the adversarial training candidates in certain regions.

After the combined adversarial networks are initially trained, the candidate database will contain design candidates and the design candidates' corresponding values of metrics and objective functions. This data can be reviewed, interrogated, or evaluated in the furtherance of optimization.

After the combined adversarial networks are initially trained, the discriminator network can be used to quickly and efficiently evaluate new design candidates by estimating values of metrics or objective functions. The discriminator network can assist in the evaluation of new, human-designed design candidates or can be utilized to evaluate the sensitivity of the metrics and objective functions to changes in inputs and/or design variables. Conventional optimization methods frequently suffer from a lack of transparency to the user. The speed and ease with which the user can interrogate not only the candidate database, but also the discriminator and generator networks, can serve to make the current invention comparatively more transparent.

In one embodiment of the current invention, by virtue of its greater capability to recognize and take advantage of patterns within data from evaluated candidates, the current invention can require fewer evaluations to achieve optimization. For example, the current invention is able to take account of relationships between design variables. Indeed with conventional optimization algorithms it is often good practice to choose design variables such that they act independently on the objective function. The current invention may make such careful parameterization redundant. The comparative improvement, i.e. the reduction in the number of evaluations, will generally be more pronounced for more complex optimization problems. When used in multi-objective optimization, the constituent networks can recognize patterns across all dimensions and regions of the Pareto front and make efficient use of that information to converge on the optimum with fewer iterations.

In one embodiment, the current invention can be used to solve either the full form of the optimization problem, or a simplified or parameterized form of the problem. However, due to the efficient use of information, less simplification may be required. This allows the invention to search a less restricted design space and yield a result closer to the true optimum.

In one embodiment of the current invention, the use of specialized layers can promote the efficient use of information contained within the candidate database, including the values of metrics, objective functions, etc. For example, convolutional layers can allow the combined adversarial networks to take advantage of spatial relationships when performing geometry optimization.

In one embodiment of the present invention, where design candidates contain repeated patterns (for example, microstructures or metamaterials in lightweight, additively manufactured parts) the combined adversarial networks can take advantage of the spatial invariance of convolutional neural networks to achieve extra efficiency.

Due to the stochastic nature of training and the additional noise layers, the current invention is less prone to getting stuck in local minima than many other optimization algorithms. Its ability to quickly find global minima could be further improved through the use of a fully Bayesian discriminator.

In one embodiment, the current invention does not require derivatives of the objective function or other information besides the objective function output values to perform optimization.

Because of the noise layers, the generator network can produce any number of different candidates, even when used for single-objective optimization. And because the discriminator network can be trained on any number of samples, many such design candidates can provide useful information. The combined network can therefore make efficient use of highly parallelized design candidate evaluations. The method may comprise the use of target values, quality weights, and noise layers to generate numerous candidates for parallel evaluation by the objective function, thereby accelerating the process and making efficient use of resources.

Because the invention can maintain a candidate database of evaluated candidates, can reuse them during training, and can recognize patterns in the data, the combined adversarial networks can make efficient use of data from prior designs, including those created by humans. This effectively allows the algorithm to learn from the fruits of human intelligence. It also allows users to interact with and influence the optimization by inserting new candidates at any point in the process.

For problems in which many different candidates may yield the same values for the metrics and objective functions, the multiple networks of the invention may allow the user to capture the full complexity of the problem, but still reduce the output space to the desired size. The combined network arrangement of the current invention may enable the discriminator network to output the same estimated performance for any number of designs, but the generator network can still be tuned to produce as few outputs as desired. This enables the invention to optimize objective functions which do not have a one-to-one mapping from inputs to outputs without producing an unwieldly number of outputs.

In one embodiment of the present invention, the method may comprise optimizing geometric designs, for example designs of mechanical parts, aerodynamic surfaces, proteins, etc. The method may comprise optimizing a geometric design utilizing metamaterials or additively-manufactured repeating patterns, thereby utilizing convolutional networks to represent these subscale structures in a computationally efficient manner. The method may comprise optimizing control inputs, for example in robots or autonomous vehicles.

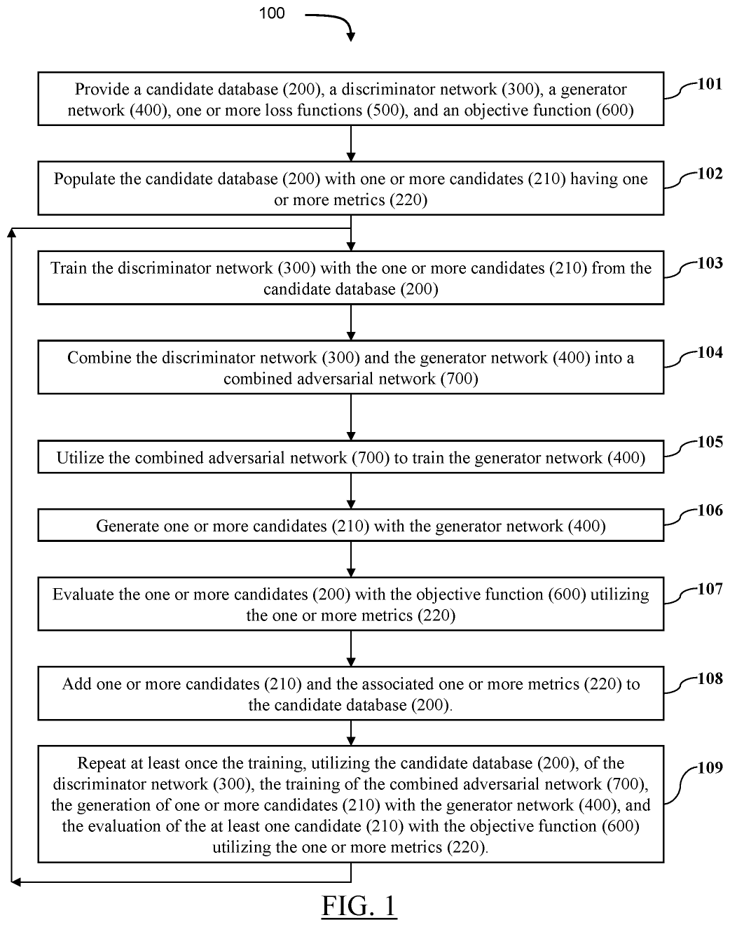

Referring now to FIG. 1, FIG. 1 is a flow diagram outlining example method steps for training, providing, and/or using a combined adversarial-trained network. The method steps can be implemented by any of the example means described herein or by any means that would be known to one of ordinary skill in the art.

Referring to a method 100 outlined in FIG. 1, in step 101 providing a candidate database (200), a discriminator network (300), a generator network (400), one or more loss functions (500), and an objective function (600).

In step 102, the method comprises populating the candidate database (200) with one or more candidates (210) having one or more metrics (220). The candidate database (200) of design candidates (210) may be labeled with one or more metrics (220). This candidate database (200) may be initially populated with existing, human-designed candidates, random noise, or any other type of candidate, so long as the one or more metrics (220) are associated with the respective candidate (210). In step 103, the method comprises training the discriminator network (300) with the one or more candidates (210) from the candidate database (200). In step 104, the method comprises combining the discriminator network (300) and generator network (400) into a combined adversarial network (700). In step 105, the method comprises utilizing the combined adversarial network (700) to train the generator network (400). In step 106, the method comprises generating one or more candidates (210) with the generator network (400). In step 107, the method comprises evaluating the one or more candidates (210) with the objective function (600) utilizing the one or more metrics (210). In step 108, the method comprises adding one or more candidates (210) and the associated one or more metrics (220) to the candidate database (200). In step 109, the method comprises repeating at least once training, utilizing the candidate database (200), of the discriminator network (300), the training of the combined adversarial network (700), the generation of one or more candidates (210) with the generator network (400), and the evaluation of the at least one candidate (210) with the objective function (600) utilizing the one or more metrics (220). FIG. 1 includes arrows to depict the potential repetitive nature of the training, combining, utilizing, generating, evaluating, and adding steps as detailed in steps 103-108. The method should be understood to include steps 103-108 with or without the arrows. Because the invention can maintain an candidate database (200) of candidates (210), can reuse the evaluated candidates (210) during training, and can recognize patterns in the data, the combined adversarial network (700) may make efficient use of data from prior designs, including those created by humans. This effectively allows the algorithm to learn from the fruits of human intelligence. It also allows users to interact with and influence the optimization by inserting new candidates at any point in the process.

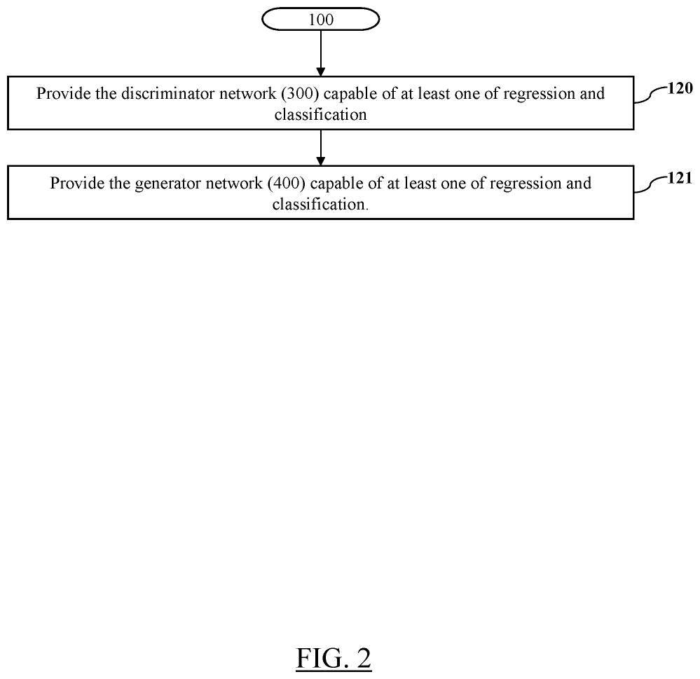

Referring to a method outlined in FIG. 2, in step 120 the method may further comprise providing the discriminator network (300) capable of at least one of regression and classification and in step 121, providing the generator network (400) capable of at least one of regression and classification.

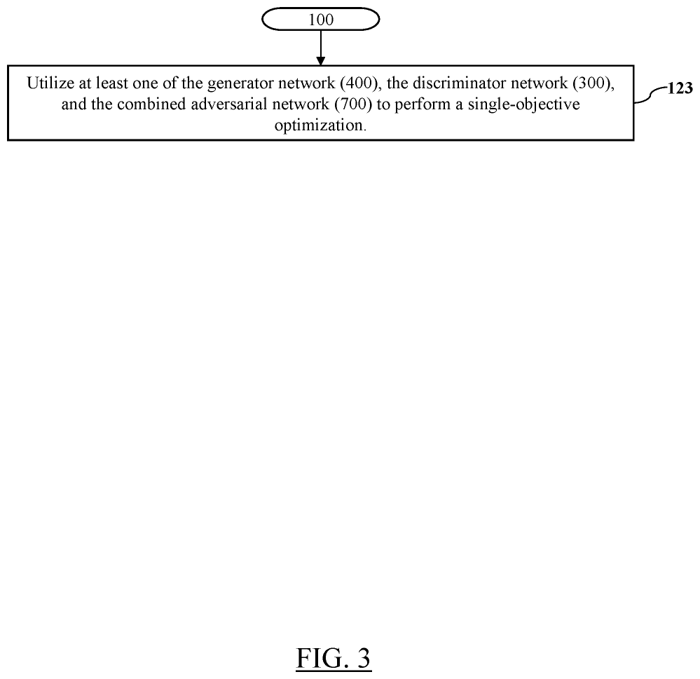

Referring to a method outlined in FIG. 3, in step 123 the method may further comprise utilizing at least one of the generator network (400), the discriminator network (300), and the combined adversarial network (700) to perform a single-objective optimization.

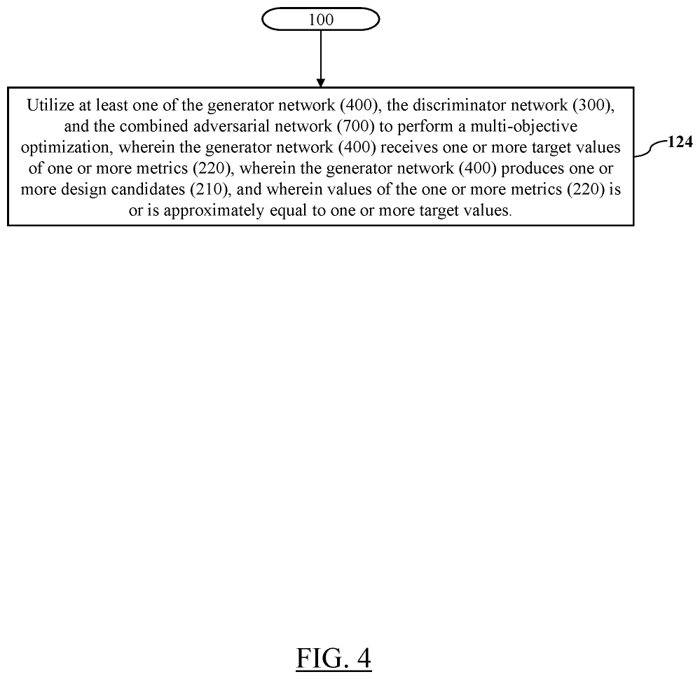

Referring to a method outlined in FIG. 4, in step 124 the method may further comprise utilizing at least one of the generator network (400), the discriminator network (300), and the combined adversarial network (700) to perform a multi-objective optimization, wherein the generator network (400) receives one or more target values of one or more metrics (220), wherein the generator network (400) produces one or more design candidates (210), and wherein values of the one or more metrics (220) is or is approximately equal to one or more target values.

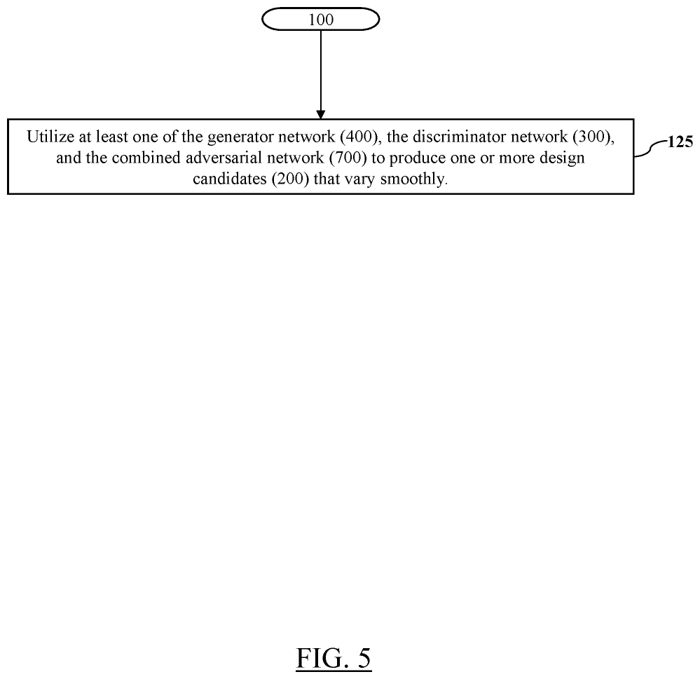

Referring to a method outlined in FIG. 5, in step 125 the method may further comprise utilizing at least one of the generator network (400), the discriminator network (300), and the combined adversarial network (700) to produce one or more design candidates (210) that vary smoothly.

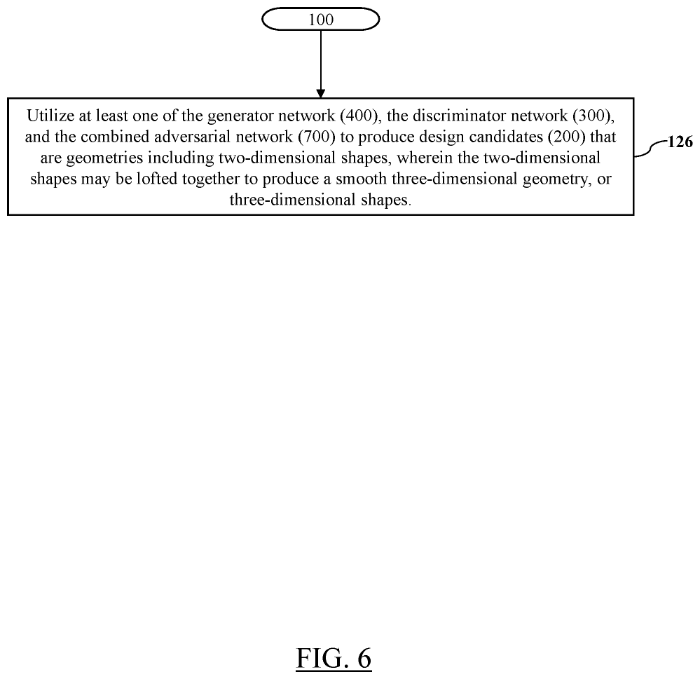

Referring to a method outlined in FIG. 6, in step 126 the method may further comprise utilizing at least one of the generator network (400), the discriminator network (300), and the combined adversarial network (700) to produce design candidates (210) that are geometries including two-dimensional shapes, wherein the two-dimensional shapes may be lofted together to produce a smooth three-dimensional geometry, or three dimensional shapes.

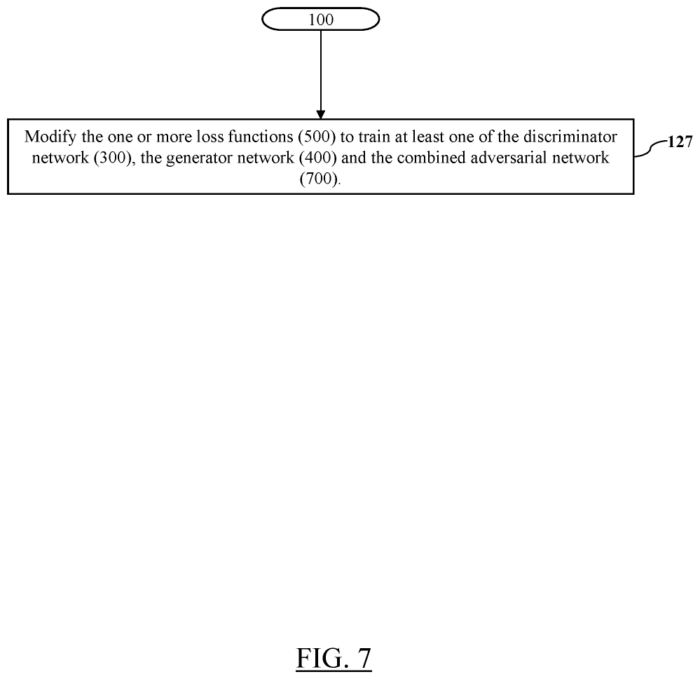

Referring to a method outlined in FIG. 7, in step 127 the method may further comprise modifying the one or more loss functions (500) to train at least one of the discriminator network (300), the generator network (400) and the combined adversarial network (700).

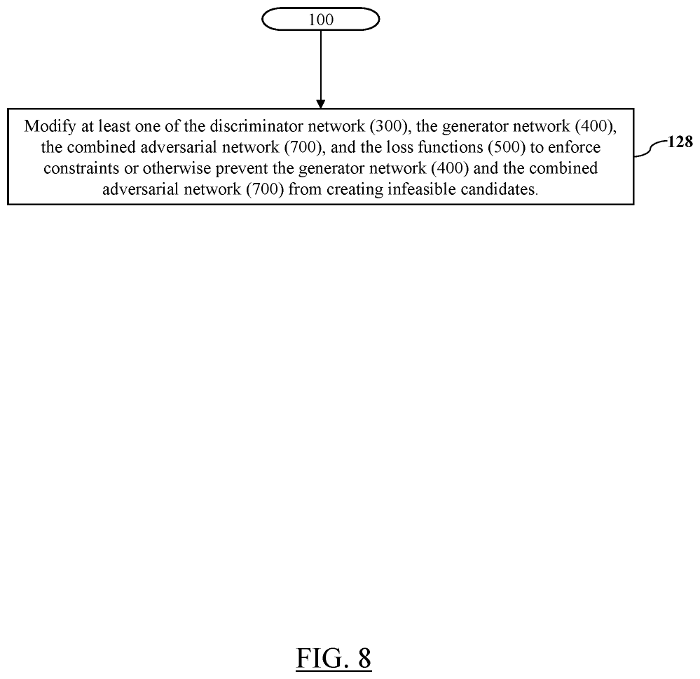

Referring to a method outlined in FIG. 8, in step 128 the method may further comprise modifying at least one of the discriminator network (300), the generator network (400), the combined adversarial network (700), and the loss functions (500) to prevent the generator network (400) and the combined adversarial network (700) from creating infeasible candidates.

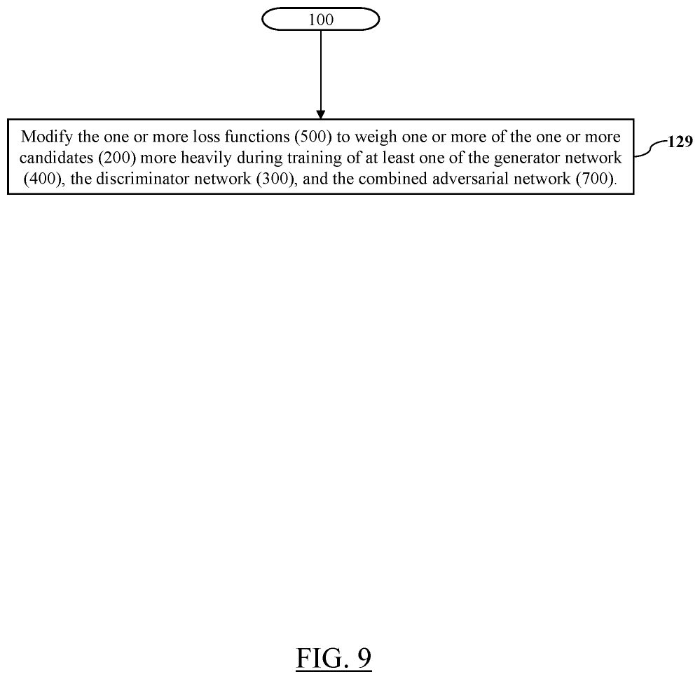

Referring to a method outlined in FIG. 9, in step 129 the method may further comprise modifying the one or more loss functions (500) to weigh one or more of the one or more candidates (210) more heavily during training of at least one of the generator network (400), the discriminator network (300), and the combined adversarial network (700).

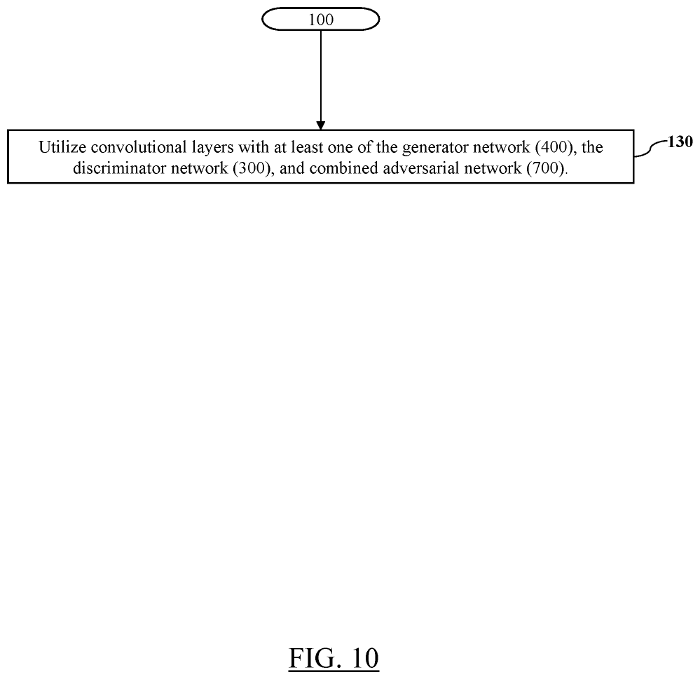

Referring to a method outlined in FIG. 10, in step 130 the method may further comprise utilizing convolutional layers with at least one of the generator network (400), the discriminator network (300), and the combined adversarial network (700).

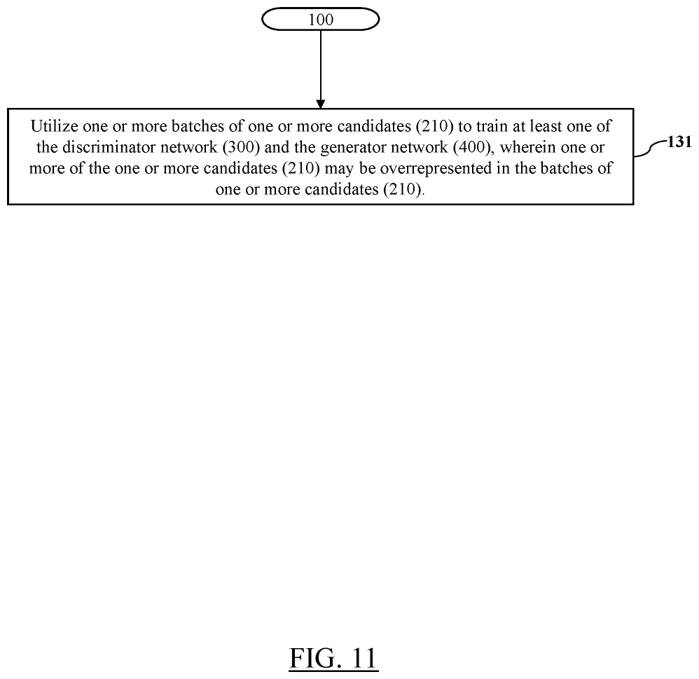

Referring to a method outlined in FIG. 11, in step 131 the method may further comprise utilizing one or more batches of one or more candidates (210) to train at least one of the discriminator network (300) and the generator network (400), wherein one or more of one or more candidates (210) may be overrepresented in the batches of the one or more candidates (210).

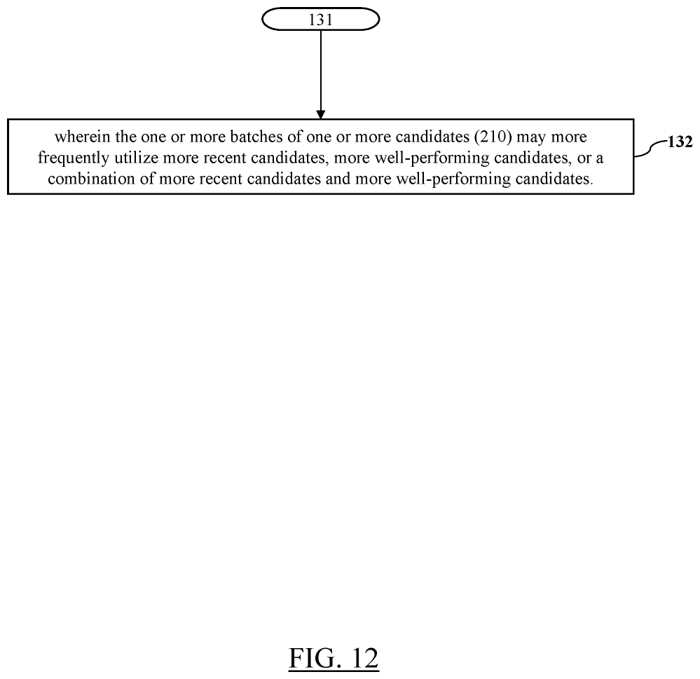

Referring to a method outlined in FIG. 12, in step 132 the method may further comprise the one or more batches of one or more candidates may more frequently utilize more recent candidates, more well-performing candidates, or a combination of more recent candidates and more well-performing candidates

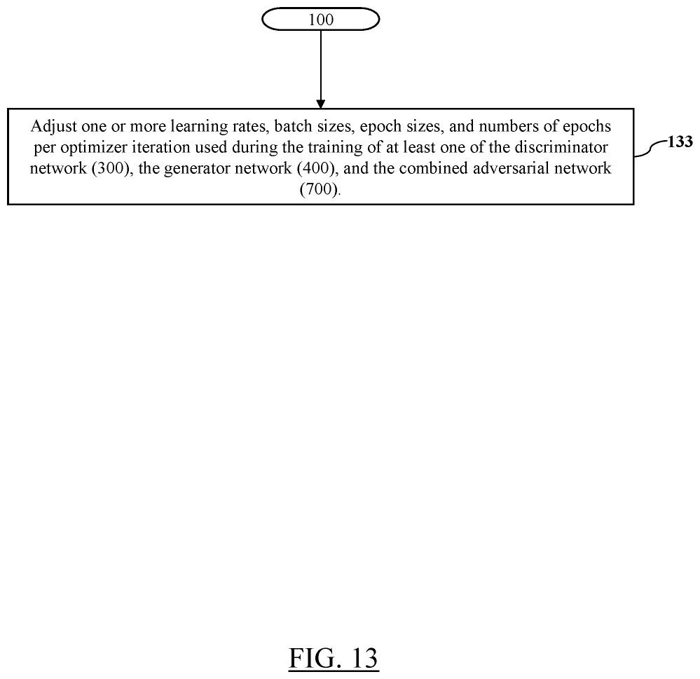

Referring to a method outlined in FIG. 13, in step 133 the method may further comprise adjusting one or more learning rates, a batch size, a corpus size, and one or more epochs of at least one of the generator network (400), the discriminator network (300), and the combined adversarial network (700).

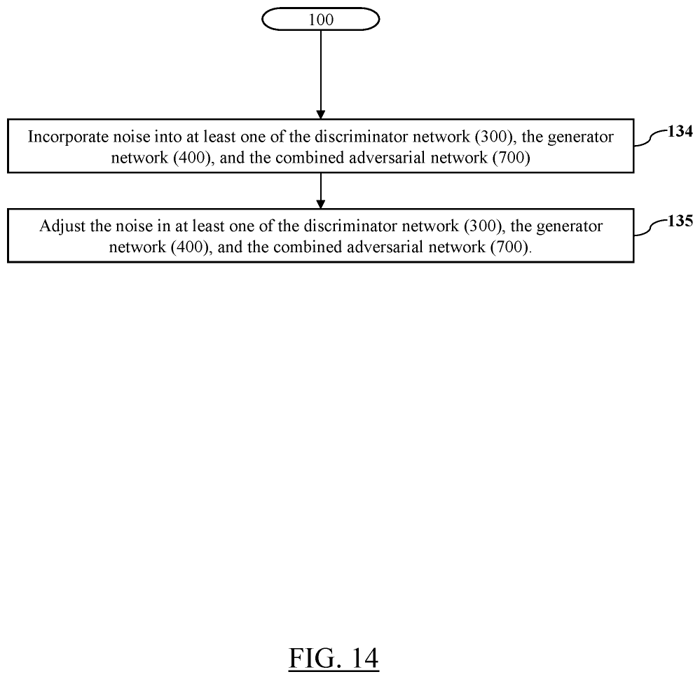

Referring to a method outlined in FIG. 14, in step 134 the method may further comprise incorporating noise into at least one of the discriminator network (300) and the generator network (400). In step 135, the method may further comprise adjusting the noise in at least one of the discriminator network (300) and the generator network (400).

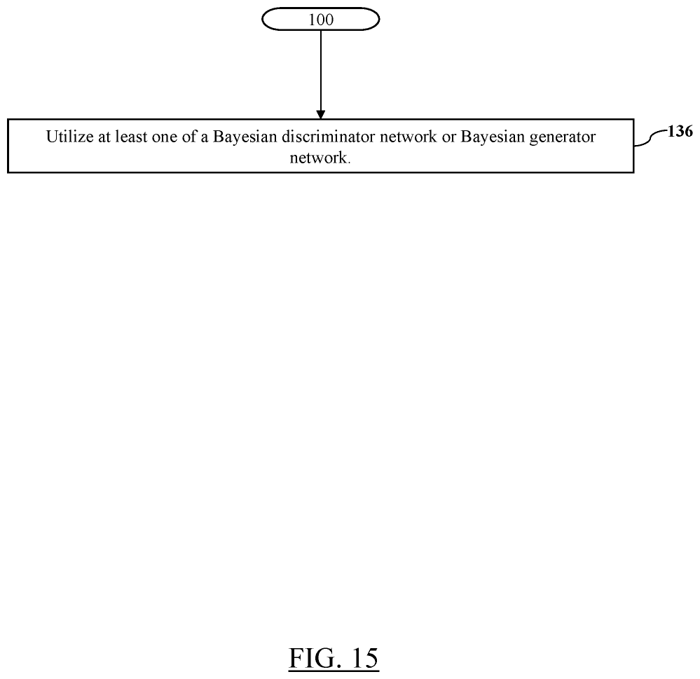

Referring to a method outlined in FIG. 15, in step 136 the method may further comprise utilizing at least one of a Bayesian discriminator network or Bayesian generator network.

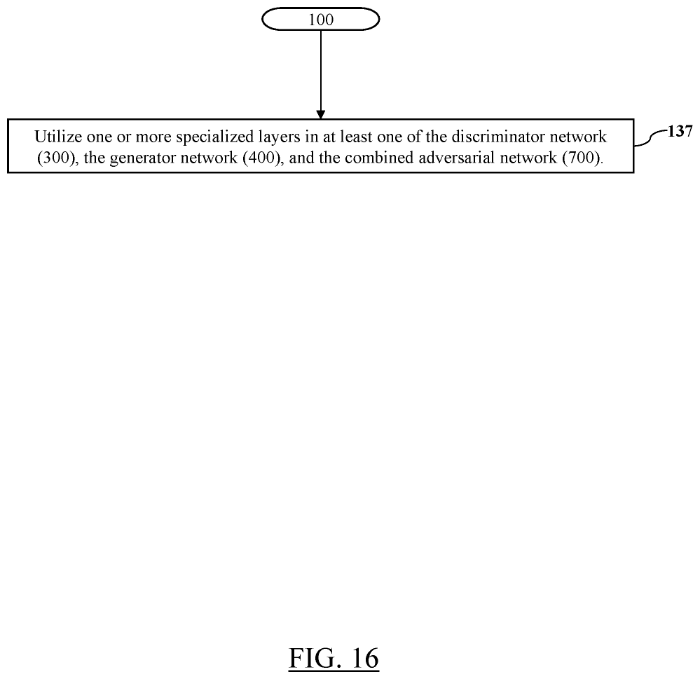

Referring to a method outlined in FIG. 16, in step 137 the method may further comprise utilizing one or more specialized layers in at least one of the generator network (400), the discriminator network (300), and the combined adversarial network (700).

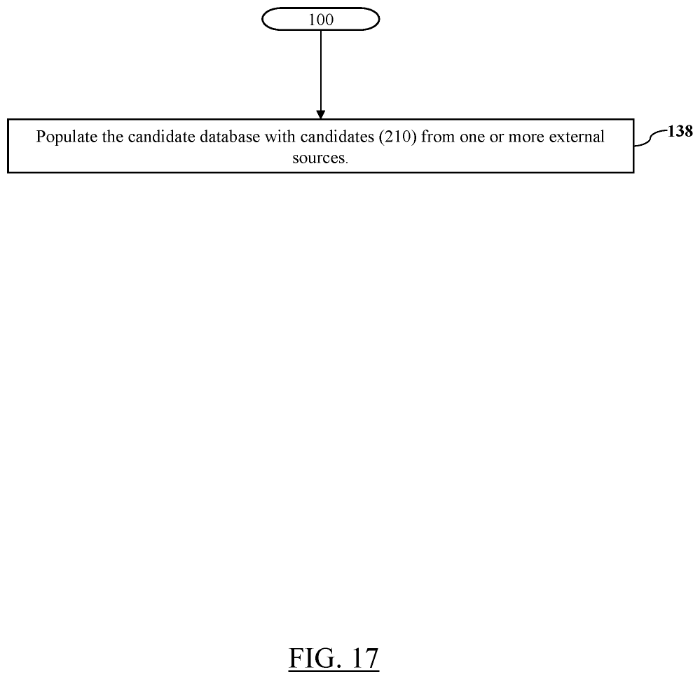

Referring to a method outlined in FIG. 17, in step 138 the method may further comprise populating the candidate database (200) with candidates (210) from one or more external sources.

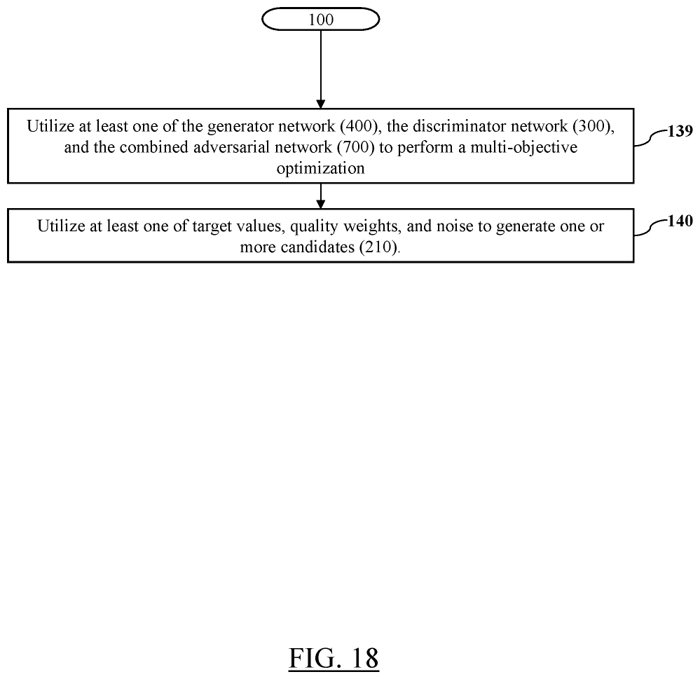

Referring to a method outlined in FIG. 18, in step 139 the method may further comprise utilizing at least one of the generator network (400), the discriminator network (300), and the combined adversarial network (700) to perform a multi-objective optimization, In step 140, the method may further comprise utilizing at least one of target values, quality weights, and noise to generate one or more candidates (210).

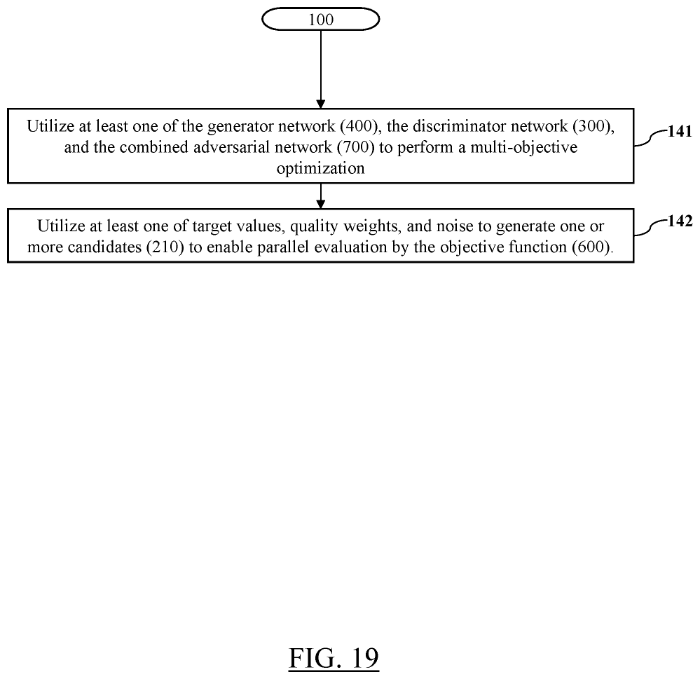

Referring to a method outlined in FIG. 19, in step 141 the method may further comprise utilizing at least one of the generator network (400), the discriminator network (300), and the combined adversarial network (700) to perform a multi-objective optimization. In step 142, utilizing at least one of target values, quality weights, and noise to generate one or more candidates (210) to enable parallel evaluation by the objective function (600).

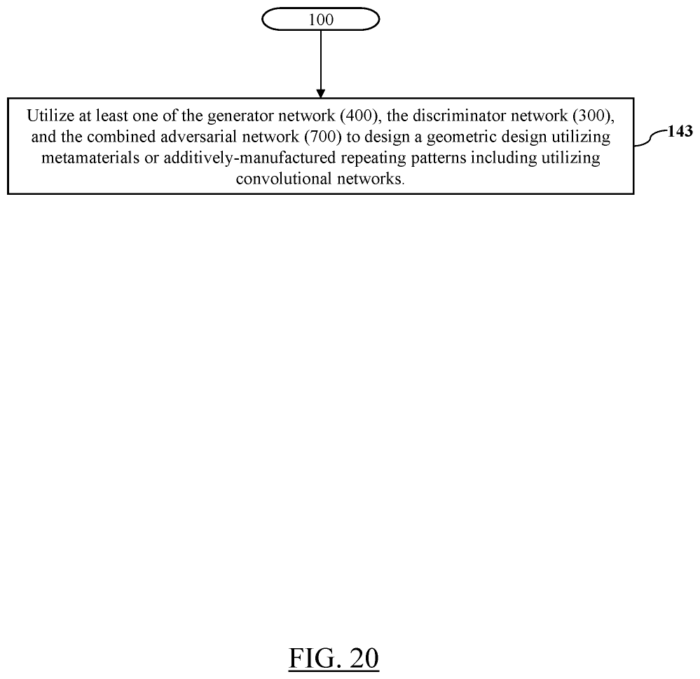

Referring to a method outlined in FIG. 20, in step 143 the method may further comprise utilizing at least one of the generator network (400), the discriminator network (300), and the combined adversarial network (700) to design a geometric design utilizing metamaterials or additively-manufactured repeating patterns including utilizing convolutional networks.

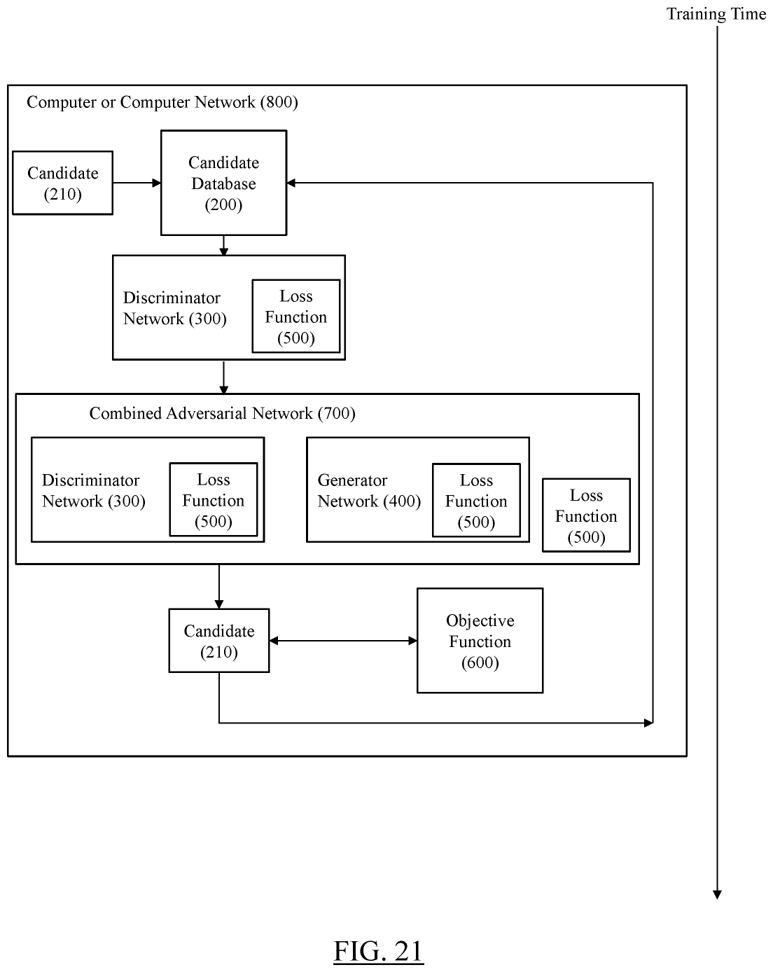

FIG. 21 illustrates a conceptual diagram of modifications of the combined adversarial network (700) within a computer or a computer network (800) during training and utilization, in accordance with an embodiment. Training of the combined adversarial network (700) begins at the top of FIG. 21 and continues to the bottom of FIG. 21 at the topology of the combined adversarial network (700) is modified to add, remove, or incorporate layers, add, remove, or incorporate aspects, and add, remove, or incorporate connections between aspects. Layers and aspects may be added to both the discriminator network (300) and the generator network (400).

The descriptions contained herein are examples of embodiments of the invention and are not intended in any way to limit the scope of the invention. As described herein, the invention contemplates many variations and modifications of the methods. These modifications would be apparent to those having ordinary skill in the art to which this invention relates and are intended to be within the scope of the claims which follow.

1. A method of optimization, the method comprising:
providing a candidate database, a discriminator network, a generator network, one or more loss functions, and an objective function;
populating the candidate database with one or more candidates having one or more metrics;
training the discriminator network with the one or more candidates from the candidate database;
combining the discriminator network and the generator network into a combined adversarial network;
utilizing the combined adversarial network to train the generator network;
generating one or more candidates with the generator network;
evaluating the at least one candidate with the objective function utilizing the one or more metrics;
adding one or more candidates and the associated one or more metrics to the candidate database; and
repeating at least once the training, utilizing the candidate database, of the discriminator network, the training of the combined adversarial network, the generation of one or more candidates with the generator network, and the evaluation of the at least one candidate with the objective function utilizing the one or more metrics.

2. The method of optimization of claim 1, the method further comprising:
providing the discriminator network capable of at least one of regression and classification; and
providing the generator network capable of at least one of regression and classification.

3. The method of optimization of claim 1, the method further comprising:
utilizing at least one of the generator network, the discriminator network, and the combined adversarial network to perform a single-objective optimization.

4. The method of optimization of claim 1, the method further comprising:
utilizing at least one of the generator network, the discriminator network, and the combined adversarial network to perform a multi-objective optimization, wherein the generator network receives one or more target values of one or more metrics, wherein the generator network produces one or more design candidates, and wherein values of the one or more metrics is or is approximately equal to one or more target values.

5. The method of optimization of claim 1, the method further comprising:
utilizing at least one of the generator network, the discriminator network, and the combined adversarial network to produce one or more design candidates that vary smoothly.

6. The method of optimization of claim 1, the method further comprising:
utilizing at least one of the generator network, the discriminator network, and the combined adversarial network to produce design candidates that are geometries including two-dimensional shapes, wherein the two-dimensional shapes may be lofted together to produce a smooth three-dimensional geometry, or three-dimensional shapes.

7. The method of optimization of claim 1, the method further comprising:
modifying the one or more loss functions to train at least one of the discriminator network, the generator network, and the combined adversarial network.

8. The method of optimization of claim 1, the method further comprising:
modifying at least one of the discriminator network, the generator network, the combined adversarial network, and the loss functions to enforce constraints or otherwise prevent the generator network and the combined adversarial network from creating infeasible candidates.

9. The method of optimization of claim 1, the method further comprising:
modifying the one or more loss functions to weigh one or more of the one or more candidates more heavily during training of at least one of the generator network, the discriminator network, and the combined adversarial network.

10. The method of optimization of claim 1, the method further comprising:
utilizing convolutional layers with at least one of the generator network, the discriminator network, and combined adversarial network.

11. The method of optimization of claim 1, the method further comprising:
utilizing one or more batches of one or more candidates to train at least one of the discriminator network and the generator network,
wherein one or more of the one or more candidates may be overrepresented in the batches of one or more candidates.

12. The method of optimization of claim 11, the method further comprising:
wherein the one or more batches of one or more candidates may more frequently utilize more recent candidates, more well-performing candidates, or a combination of more recent candidates and more well-performing candidates.

13. The method of optimization of claim 1, the method further comprising:
adjusting one or more learning rates, batch sizes, epoch sizes, and numbers of epochs per optimizer iteration used during the training of at least one of the discriminator network, the generator network, and the combined adversarial network.

14. The method of optimization of claim 1, the method further comprising:
incorporating noise into at least one of the discriminator network, the generator network and the combined adversarial network; and
adjusting the noise in at least one of the discriminator network, the generator network, and the combined adversarial network.

15. The method of optimization of claim 1, the method further comprising:
utilizing at least one of a Bayesian discriminator network or Bayesian generator network.

16. The method of optimization of claim 1, the method further comprising:
utilizing one or more specialized layers in at least one of the discriminator network, the generator network, and the combined adversarial network.

17. The method of optimization of claim 1, the method further comprising:
populating the candidate database with candidates from one or more external sources.

18. The method of optimization of claim 1, the method further comprising:
utilizing at least one of the generator network, the discriminator network, and the combined adversarial network to perform a multi-objective optimization;
utilizing at least one of target values, quality weights, and noise to generate one or more candidates.

19. The method of optimization of claim 1, the method further comprising:
utilizing at least one of the generator network, the discriminator network, and the combined adversarial network to perform a multi-objective optimization;
utilizing at least one of target values, quality weights, and noise to generate one or more candidates to enable parallel evaluation by the objective function.

20. The method of optimization of claim 1, the method further comprising:
utilizing at least one of the generator network, the discriminator network, and the combined adversarial network to design a geometric design utilizing metamaterials or additively-manufactured repeating patterns including utilizing convolutional networks.
